(19) United States
(12) Patent Application Publication
(10) Pub. No.: US 2017/0140857 A1
(43) Pub. Date: May 18, 2017

(54) MODIFIED MAGNETIC COIL STRUCTURE

(71) Applicant: KINSUS INTERCONNECT TECHNOLOGY CORP., Taoyuan (TW)

(72) Inventors: Ting-Hao Lin, Taipei (TW); Chiao-Cheng Chang, Taoyuan City (TW); Yi-Nong Lin, Keelung City (TW)

(21) Appl. No.: 14/943,077

(22) Filed: Nov. 17, 2015

(51) Int. Cl. H01F 5/00

(52) U.S. Cl. CPC H01F 5/003

(57) ABSTRACT

Disclosed is a modified magnetic coil structure. A substrate, at least one circuit pattern layer and a permeability enforced ring are included. The substrate is formed of an electrical insulation material, and has a through hole. The circuit pattern layer is formed of an electrically conductive material and configured in the substrate to surround but not contact the through hole. The permeability enforced ring is formed of a high permeability material and provided in the through hole so as to fully cover a sidewall of the through hole. The permeability enforced ring and the substrate form two co-planes in an upper horizontal plane and a lower horizontal plane of the modified magnetic coil structure, respectively. Therefore, the present invention employs the permeability enforced ring to greatly increase magnetic flux density to form a high permeability device, thereby improving the electromagnetic effect and properties of the magnetic coil.

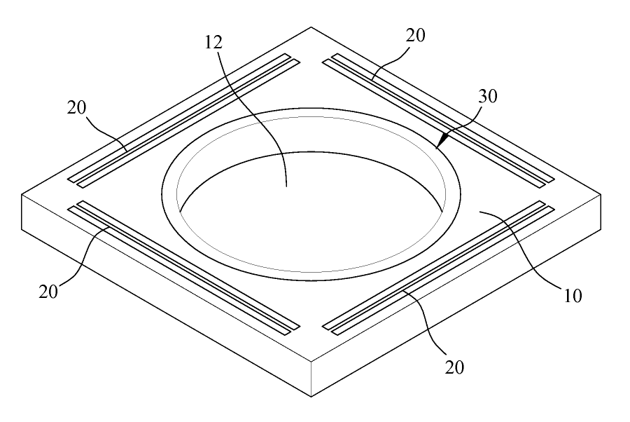

### BACKGROUND OF THE INVENTION

1. Field of the Invention

The present invention generally relates to a modified magnetic coil structure, and more specifically to a modified magnetic coil structure employing a permeability enforced ring configured in a through hole of a substrate to fully cover a sidewall of the through hole so as to increase overall permeability property.

2. The Prior Arts

Traditional magnetic coils are constructed by substrate with a through hole in the center, and a circuit pattern on the substrate. The substrate is generally formed of an electrical insulation material and the circuit pattern is formed of an electrically conductive material and configured to surround but not contact the through hole. Therefore, when the magnetic field within the through hole varies, the circuit pattern may generate induced electric field due to the electromagnetic effect. Accordingly, when the electric field within the through hole varies, the circuit pattern may generate induced magnetic field. Currently, the magnetic coil is one of the widely used basic electromagnetic elements.

However, owing to the limit design of the circuit pattern layer like the smallest width of the conductive connection and the smallest pitch between two adjacent conductive connections, the packing density of the conductive connections can not be further improved. As a result, the overall electromagnetic effect of the magnetic coil is quite limited.

Therefore, it is greatly needed to provide a new modified magnetic coil structure employing a permeability enforced ring configured in a through hole of a substrate to fully cover a sidewall of the through hole so as to increase overall permeability property like magnet flux density, thereby overcoming the above problems in the prior arts.

### SUMMARY OF THE INVENTION

The primary objective of the present invention is to provide a modified magnetic coil structure. The modified magnetic coil structure of the present invention comprises a substrate, at least one circuit pattern layer and a permeability enforced ring for exhibiting the electromagnetic effect like high magnetic flux density. Specifically, the substrate is formed of an electrical insulation material, and has a through hole with a closed shape such as a circle, an ellipse, a square or a rectangle. The circuit pattern layer is formed of an electrically conductive material and configured in the substrate to surround but not contact the through hole. The circuit pattern layers are electrically isolated to each other.

The permeability enforced ring is formed of a high permeability material and provided in the through hole so as to fully cover a sidewall of the through hole. The electrically conductive material comprises a copper foil, and the high permeability material comprises zinc electroplated steel, medium carbon steel, permalloy, nickel iron alloy or nickel steel sheets.

In addition, the permeability enforced ring and the substrate form two co-planes in an upper horizontal plane and a lower horizontal plane, respectively. In other words, the connection regions of the substrate and the permeability enforced ring in the upper horizontal plane and the lower horizontal plane of the modified magnetic coil structure of the present invention are smooth.

Since larger magnetic flux density and improved magnetic effect can be obtained under the same magnetic strength for the permeability enforced ring formed of the high permeability material, the modified magnetic coil structure of the present invention may greatly improve the overall electromagnetic effect and the properties of the magnetic coil.

### BRIEF DESCRIPTION OF THE DRAWINGS

The present invention can be understood in more detail by reading the subsequent detailed description in conjunction with the examples and references made to the accompanying drawings, wherein:

FIGURE is a perspective view showing the modified magnetic coil structure according to one embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

Please refer to FIGURE showing the modified magnetic coil structure according to one embodiment of the present invention. As shown in FIGURE, the modified magnetic coil structure of the present invention generally comprises a substrate 10, at least one circuit pattern layer 20 and a permeability enforced ring 30 for exhibiting the electromagnetic effect like high magnetic flux density. Specifically, the substrate 10 is formed of an electrical insulation material, and preferably has a square shape in a horizontal sectional area. The substrate 10 further has a thickness in a vertical direction and comprises a through hole 10 with a closed shape penetrating the thickness in the vertical direction. Particularly, the sectional shape of the through hole 10 is a closed shape like a circle, an ellipse, a square or a rectangle.

The circuit pattern layer 20 is substantially formed of an electrically conductive material like copper foil, and specifically configured in the substrate 10 to surround but not contact the through hole 12. In particular, the circuit pattern layers 20 are electrically isolated to each other.

It should be noted that FIGURE only shows one single circuit pattern layer 20 for simplicity, and is not intended to limit the scope of the present invention. In other words, the present invention may comprise additional circuit pattern layers 20 in the substrate 10 and electrically connected.

The permeability enforced ring 30 is formed of a high permeability material and provided in the through hole 12 so as to fully cover the sidewall of the through hole 12. It is preferred that the electrically conductive material comprises a copper foil, and the high permeability material comprises zinc electroplated steel, medium carbon steel, permalloy, nickel iron alloy or nickel steel sheets.

Moreover, the permeability enforced ring 30 and the substrate 10 form two co-planes in an upper horizontal plane and a lower horizontal plane, respectively. That is, the connection regions of the substrate 10 and the permeability enforced ring 30 in the upper horizontal plane and the lower horizontal plane of the modified magnetic coil structure of the present invention are smooth.

Since larger magnetic flux density and improved magnetic effect can be obtained under the same magnetic strength for the permeability enforced ring 30 formed of the high permeability material, the modified magnetic coil structure of the present invention may greatly improve the overall electromagnetic effect and the properties of the magnetic coil.

From the above mention, one primary feature of the present invention is that the overall structure is quite simple with the permeability enforced ring placed in the through hole of the substrate such that the magnetic flux density within the through hole is greatly increased and the overall electromagnetic effect and the properties of the magnetic coil are improved, thereby expanding the application field.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A modified magnetic coil structure, comprising:
a substrate formed of an electrical insulation material, having a thickness in a vertical direction, and comprising a through hole penetrating the thickness in the vertical direction and having a closed shape in a horizontal sectional area;
a circuit pattern layer formed of an electrically conductive material and configured in the substrate to surround the through hole, wherein the circuit pattern layer does not contact the through hole; and
a permeability enforced ring formed of a high permeability material, provided in the through hole, and fully covering a sidewall of the through hole.

2. The modified magnetic coil structure as claimed in claim 1, wherein the closed shape comprises a circle, an ellipse, a square or a rectangle.

3. The modified magnetic coil structure as claimed in claim 1, wherein the electrically conductive material comprises a copper foil, and the high permeability material comprises zinc electroplated steel, medium carbon steel, permalloy, nickel iron alloy or nickel steel sheets.

4. The modified magnetic coil structure as claimed in claim 1, wherein the permeability enforced ring and the substrate form two co-planes in an upper horizontal plane and a lower horizontal plane of the modified magnetic coil structure, respectively.

5. A modified magnetic coil structure, comprising:
a substrate formed of an electrical insulation material, having a thickness in a vertical direction, and comprising a through hole penetrating the thickness in the vertical direction and having a closed shape in a horizontal sectional area, wherein the substrate has a square shape in a horizontal sectional area;
a plurality of circuit pattern layers formed of an electrically conductive material and configured in the substrate to surround the through hole, wherein the circuit pattern layers do not contact the through hole and are electrically isolated to each other; and
a permeability enforced ring formed of a high permeability material, provided in the through hole, and fully covering a sidewall of the through hole.

6. The modified magnetic coil structure as claimed in claim 5, wherein the closed shape comprises a circle, an ellipse, a square or a rectangle.

7. The modified magnetic coil structure as claimed in claim 5, wherein the electrically conductive material comprises a copper foil, and the high permeability material comprises zinc electroplated steel, medium carbon steel, permalloy, nickel iron alloy or nickel steel sheets.

8. The modified magnetic coil structure as claimed in claim 5, wherein the permeability enforced ring and the substrate form two co-planes in an upper horizontal plane and a lower horizontal plane of the modified magnetic coil structure, respectively.
